(19) United States
(12) Patent Application Publication
(10) Pub. No.: US 2014/0145098 A1
(43) Pub. Date: May 29, 2014

(54) Normally Closed Magnetic Valve

(71) Applicant: Norbert Alaze, Markgroeningen (DE)

(72) Inventor: Norbert Alaze, Markgroeningen (DE)

(73) Assignee: Robert Bosch GmbH, Stuttgart (DE)

(21) Appl. No.: 13/822,263

(22) PCT Filed: Jul. 20, 2011
(86) PCT No.: PCT/EP2011/062459

§ 371 Date: May 28, 2013

(30) Foreign Application Priority Data
Sep. 13, 2010 (DE) 10 2010 040 628.7

(51) Int. Cl. F16K 31/06

(52) U.S. Cl. CPC F16K 31/06
USPC 251/65

(57) ABSTRACT

The disclosure relates to a normally closed magnetic valve, having a valve sleeve, in which a pole core is fixedly arranged and in which an armature having a valve tip is axially movable, wherein a helical spring acts between the pole core and the armature in order to push the valve tip into a valve seat. The pole core has an axial recess in which at least part of the helical spring is received in order to guide same.

The invention relates to a normally closed magnetic valve with a valve sleeve, in which a pole core is fixedly arranged and in which an armature having a valve tip is axially displaceable, wherein a helical spring acts between the pole core and the armature so as to push the valve tip into a valve seat.

### PRIOR ART

Magnetic valves of the above-mentioned type are known from the prior art. They comprise a magnetic actuator, which comprises a magnet coil, to which current can be supplied, as well as a pole core, and acts on an armature that is axially displaceable in the valve sleeve. The armature in this case has a valve tip, which is pushed against a valve seat in the de-energized state of the magnetic actuator. The armature is held in the valve sleeve in a biased manner for this purpose. A helical spring that acts, or is biased, between the pole core and the armature is normally provided to apply the bias. The helical spring is supported in this case at one end on the fixedly arranged pole core and at the other end on the displaceable armature. The armature normally has a recess, in which the helical spring is substantially inserted and guided. The part of the helical spring protruding beyond the recess is supported on the pole core and extends from the end face of the armature facing the pole core to the end face of the pole core facing the armature, the distance between these points forming a “working air gap” in the de-energized state. This working air gap determines the maximum possible path of displacement of the armature.

### DISCLOSURE OF THE INVENTION

The magnetic valve according to the invention is characterized in that the pole core has an axial recess, in which the helical spring is received, at least in some regions. In contrast to the prior art, the helical spring is thus arranged in the pole core in this instance and is guided therethrough. In particular, this provides the advantage that the effective region of the armature, which can be acted on by the magnetic force of the magnetic actuator, is larger. In addition, a press piece that is normally arranged displaceably in the armature and that acts between the helical spring and the pole core, is also omitted. On the whole, a magnetic valve is provided that has a larger magnetic effective region and is of simple design and can be easily assembled.

The end face of the armature facing the pole core preferably has a small indentation, which is used to align and support the helical spring. The end face of the armature facing the pole core is particularly preferably closed however, so as to optimize the magnetic effective region. The axial recess provided in the pole core is sufficient to support and guide the helical spring. The largest part of the helical spring is preferably located in the pole core, and the helical spring is therefore received substantially by the axial recess.

In accordance with an advantageous development of the invention a Woodruff key is arranged between the armature and the helical spring. The magnetic force normally increases significantly with an increasingly smaller working air gap. This increasing magnetic force profile hinders continuous adjustability (proportionalization) of the magnetic valve with regard to the supply of current to the magnet coils and the pressure difference set over the valve seat. The combination claimed in this instance of helical spring and Woodruff key is used to achieve an optimal spring characteristic. The helical spring and the Woodruff key are preferably arranged in parallel in this instance, wherein the minimum bias to push the valve tip into the valve seat is preferably ensured by the helical spring. In the de-energized state the Woodruff key is merely arranged in its intermediate position, but is not biased. If the magnetic valve is actuated or the magnet coils are energized, the armature moves together with the Woodruff key against the helical spring until the Woodruff key comes into operative contact with the pole core, since a resilience is likewise provided or generated. The Woodruff key preferably has a progressive characteristic curve.

In particular, the end face of the armature facing the pole core is at least substantially convex and the end face of the pole core facing the armature is at least substantially concave. This means that the Woodruff key bears against the armature substantially centrally, whereby a short force transmission path onto the helical spring is possible. In addition, the outer edge region of the pole core acts on the outer edge region of the Woodruff key when the magnetic valve is actuated, whereby maximum utilization of the Woodruff key is ensured from the center of the armature to the outer edge region of the pole core. The convex end face of the armature may dip into the concave end face of the pole core, at least in some regions, when the magnetic valve is actuated.

At least one spring stop element for setting the resilience of the helical spring is preferably arranged in the axial recess in the pole core. The spring stop element can be positioned at the desired position in the axial recess so as to determine the stop (located on the side of the pole core) or contact point of the helical spring and therefore the minimum bias of the helical spring.

The spring stop element is preferably arranged in the axial recess with a friction fit. The spring stop element can thus be pressed into the recess as far as a desired point. A simple possibility is thus provided for setting the resilience during assembly of the magnetic valve. Alternatively, it is also conceivable to arrange the spring stop element in the axial recess with an interlocking fit and/or integral bond.

In accordance with a development of the invention, the spring stop element is formed as a ball or as a sleeve. The ball advantageously has a diameter that exceeds the diameter of the axial receptacle so that a press fit is produced. The ball is then pressed into the axial recess as far as a desired point, as described above. The helical spring is in this case centered automatically in the axial recess due to the shape of the ball and of the wire forming the helical spring, which is preferably circular in cross section. Alternatively to the ball, it is also conceivable to press a cylinder into the axial recess.

It is also preferable for a further helical spring to be arranged in parallel with the helical spring, either additionally or alternatively to the above-described Woodruff key. At least two helical springs arranged in parallel are thus provided, of which one helical spring is arranged substantially in the pole core. Compared to the Woodruff key, the further helical spring provides the advantage that its resilience acting on the magnetic valve can be set more easily and more precisely.

The further helical spring is preferably arranged in an axial recess formed in the armature, wherein a press piece pushed against the pole core by the further helical spring is preferably axially displaceable in the recess. The further helical spring is thus biased in the axial recess between the press piece and the armature. For this purpose, the press piece has a portion protruding beyond the end face of the armature facing the pole core, said portion being supported directly or indirectly on the pole core. A further resilience is thus provided, which pushes the valve tip of the armature against the valve seat. The axial recess is preferably formed as a continuous axial recess, wherein one end is closed by the press piece and the opposite end is closed by a press-in part forming the valve tip. The bias of the further helical spring between the press piece and the press-in part can be set according to the insertion depth of the press-in part in the axial recess. Due to the frictional connection between the press-in part and the armature, the force of the helical spring is then transferred onto the press-in part via the armature, or, if the magnetic valve is activated or energized, the press-in part together with the valve tip is withdrawn from the valve seat, through the armature in the direction of the pole core. If the optional Woodruff key is additionally provided, this is thus biased between the press piece and the helical spring, and cooperates with the armature and the pole core when the magnetic valve is actuated, as described above.

A pin guided through the helical spring and cooperating with the press piece is preferably arranged in the axial recess in the pole core. The press piece is supported indirectly on the pole core via this pin. The pin is preferably held in the sleeve forming the spring stop or in a tapered region of the axial recess in the pole core, preferably with a friction fit. The pin expediently has an outer diameter that is smaller than the inner diameter of the helical spring, so that it is guided without friction through the helical spring, or the helical spring can be deformed without friction relative to the pin.

The invention will be explained in greater detail hereinafter on the basis of the drawing, in which:

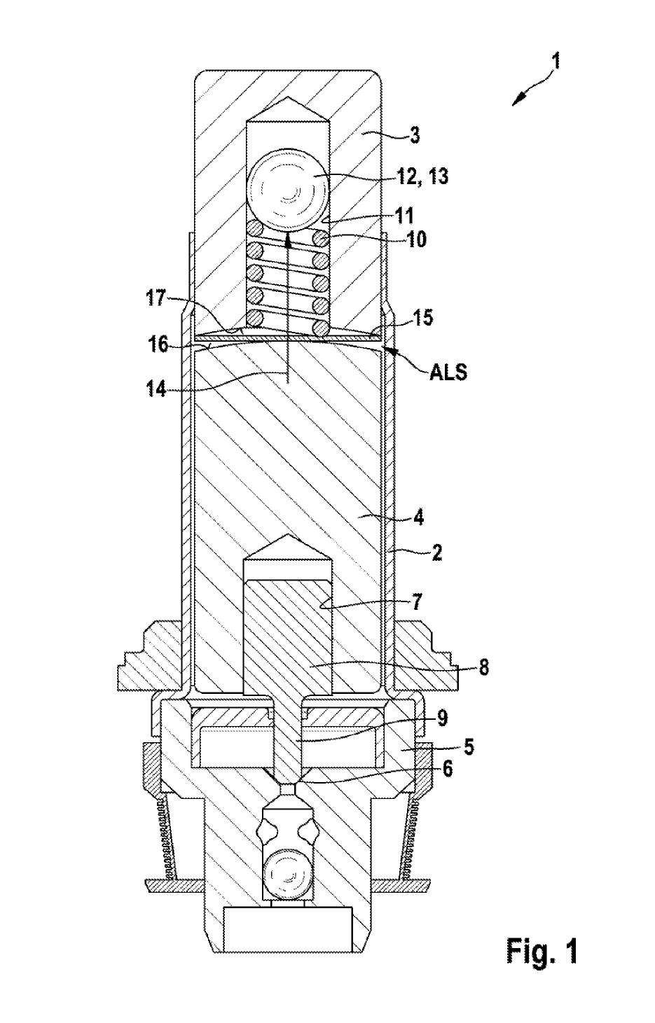

FIG. 1 shows a simplified longitudinal sectional illustration of a first exemplary embodiment of a magnetic valve,

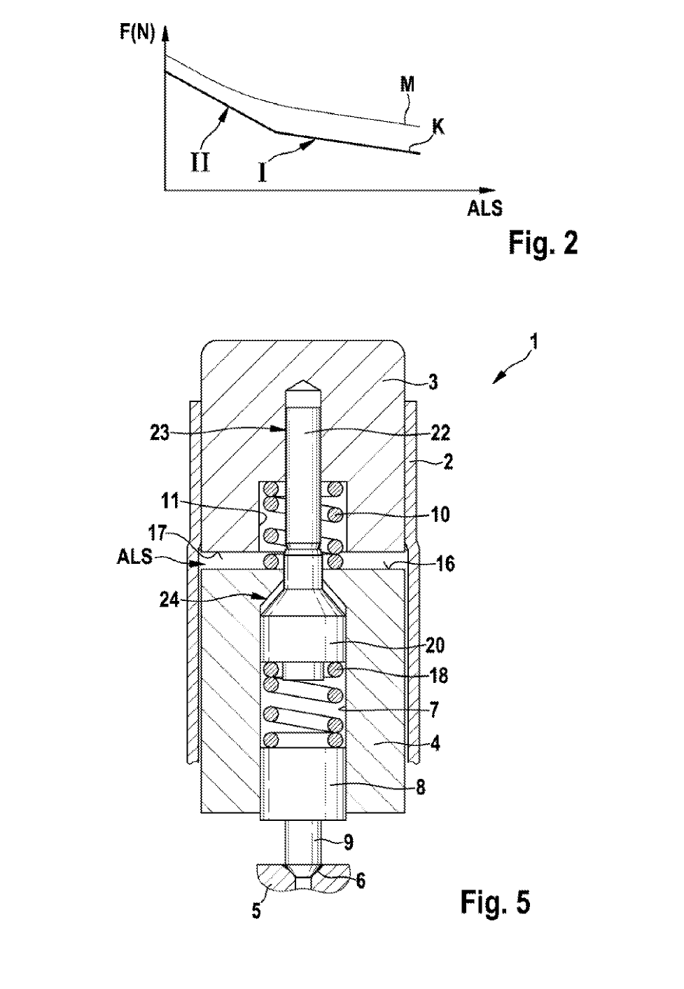

FIG. 2 shows a characteristic curve of the magnetic valve,

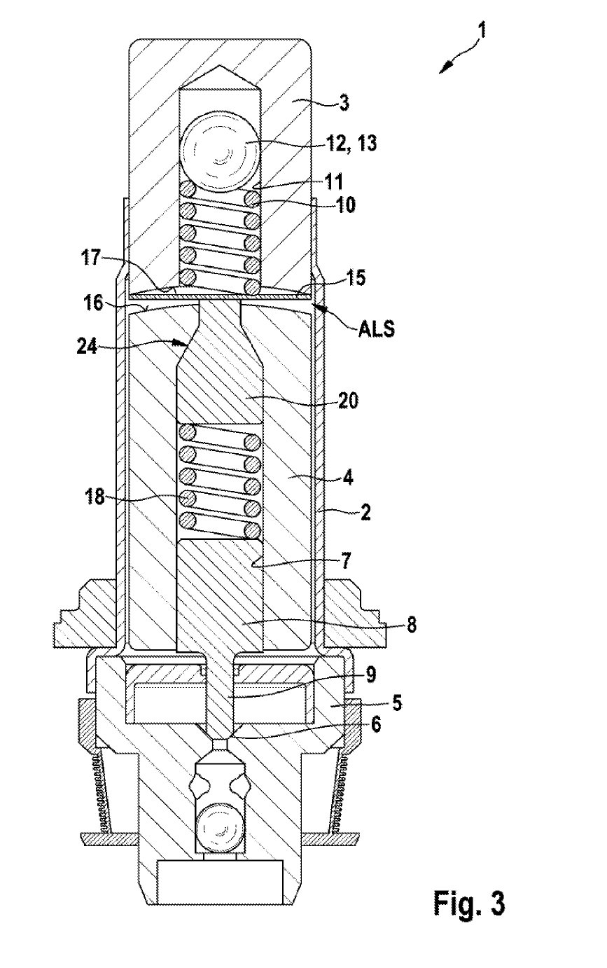

FIG. 3 shows a second exemplary embodiment of the magnetic valve with a further helical spring,

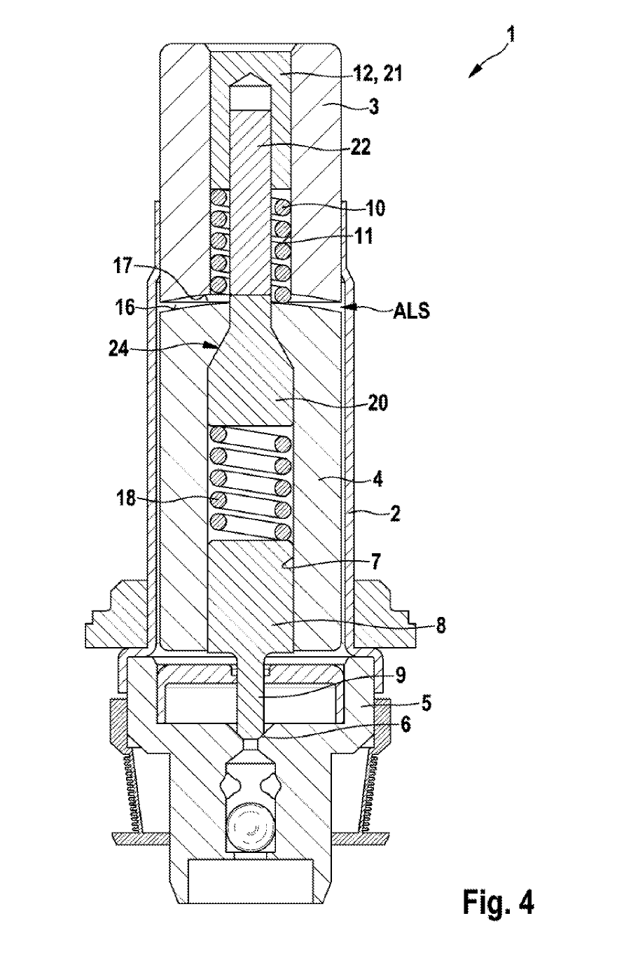

FIG. 4 shows a longitudinal sectional illustration of a third exemplary embodiment of the magnetic valve, and

FIG. 5 shows a longitudinal sectional illustration of a fourth exemplary embodiment of the magnetic valve.

FIG. 1 shows a simplified longitudinal sectional illustration of a magnetic valve 1, as is intended in particular for braking systems of motor vehicles, for example for ABS and/or ESP braking systems. The magnetic valve 1 has a valve sleeve 2, in which a pole core 3 of a magnetic actuator (not illustrated here in greater detail) is fixedly arranged. Furthermore, an armature 4 is axially displaceable in the valve sleeve 2. A valve body 5 is held on the end of the valve sleeve 2 opposite the pole core 3. The valve body 5 has a valve seat 6 surrounding a valve opening. At its end facing the valve body 5, the armature 4 has an axial recess 7, in which a press-in part 8 is held with a friction fit, wherein the press-in part 8 forms a valve tip 9, which cooperates tightly with the valve seat 6 in the de-energized state of the magnetic valve 1.

In this case a helical spring 10 is provided, which acts between the pole core 3 and the armature 4 so as to push the valve tip 9 into the valve seat 6. The helical spring 10 is in this case arranged substantially in an axial recess 11, which guides the helical spring 10 and is open at least toward the armature 4, so that the helical spring 10 extends beyond the pole core 3 and applies a bias to the armature 4. So as to set the bias, a spring stop element 12, which is formed in the present case as a ball 13, is held with a friction fit in the axial recess 11. When assembling the magnetic valve 1, the resilience of the helical spring 10 acting minimally on the valve tip 9 is determined by the press-in depth of the ball 13 in the axial recess 11. The helical spring 10 is in this case automatically centered in the axial recess 11 by the ball 13. To set the resilience, a ram can in this case be guided, during assembly, through the free interior of the helical spring 10, by means of which the ball 13 is inserted into the axial recess 11, as indicated by an arrow 14. During the process of setting the resilience, the end face 17 is considered as a reference face for the spring setting. When setting the magnetic valve 1, the resilience at the valve seat 6 is measured and the pole core 3 is pressed into the valve sleeve 2 until the necessary resilience has been reached. The setting force of the helical spring 10 is in this case slightly smaller than the setting force of the entire magnetic valve 1. Once the magnetic valve 1 has been set, the Woodruff key 15 is thus always biased in accordance with the difference in force between the set resilience of the helical spring 10 and the overall resilience of the magnetic valve 1, which leads to an improved service life of the Woodruff key 15.

An optional Woodruff key 15 is also arranged between the helical spring 10 and the armature 4. The armature 4 has an end face 16, which faces the pole core 3 and is convex, so that the Woodruff key 15, which is flat in the unloaded state, bears merely centrally against the end face 16 of the armature 4. The radial or lateral guidance of the Woodruff key 15 can be ensured in this case for example by the valve sleeve 2.

The pole core 3 has an end face 17, which faces the armature 4 and is concave and is merely interrupted by the axial recess 11. The end face 16 and the end face 17 preferably extend in parallel to one another. The helical spring 10 protrudes beyond the end face 17, at least in the region in the vicinity of the axial recess 11, so that the armature 4 is biased in the direction of the valve seat 6, whereby a working air gap ALS is ensured between the armature 4 and the pole core 3. The working air gap ALS of the magnetic valve 1 is created from the position of the armature 4 and pole core 3 once the magnetic valve has been set up, and from the spring path, still then possible, until the armature contacts the pole core 3. The working air gap ALS is preferably selected to be so large that the Woodruff key 15 is flat in the unactuated state of the magnetic valve 3.

If the magnetic valve 1 is actuated, that is to say energized, the pole core 3 thus exerts a magnetic force onto the armature 4 in such a way that the armature is pulled against the pole core in the direction of the arrow 14. In this case, only the helical spring 10 is initially elastically deformed, until the outer edge region of the Woodruff key 15 contacts the outer edge region of the end face 17 of the pole core 3. At this moment, the helical spring 10 and the Woodruff key 15 act in parallel, as is illustrated with reference to FIG. 2.

FIG. 2 shows a graph illustrating the resilience F according to the size of the working air gap ALS. In the graph, the spring characteristic curve K and the magnetic force characteristic curve M are plotted, which are both dependent on the working air gap ALS. In this case a clear difference can be seen in the spring characteristic curve K between the first characteristic curve region I, in which merely the helical spring 10 acts, and the second characteristic curve region II, in which the helical spring 10 and the Woodruff key 15 act in parallel.

Due to the omission of the press piece, that is otherwise provided conventionally, and of the corresponding helical spring in the armature 4, the bearing face of the armature 4 against the Woodruff key 15 can be reduced in diameter. The available spring arm of the Woodruff key 15 is thus increased, which leads to improved utilization of the travel stress of the Woodruff key 15. The Woodruff key 15 may optionally be formed as a soft Woodruff key, whereby the overall spring characteristic curve K is hardly affected. It is thus possible, however, to reduce the stress in the Woodruff key 15 and to thus design a durable Woodruff key 15.

As described above, a further possibility for reducing the stress in the Woodruff key 15 is to divide the total travel of the magnetic valve 1 such that the first part of the travel is taken on by the helical spring 10 and the second part of the travel is taken on by a combination of the helical spring and the Woodruff key.

A further exemplary embodiment is illustrated in FIG. 3. In contrast to the preceding exemplary embodiment, the magnetic valve 1 has a further helical spring 18. The further helical spring 18 is arranged in the axial recess 7 in the armature 4, which extends through the entire armature 4 in accordance with this exemplary embodiment. An axially displaceable press piece 20 is likewise arranged in the axial recess 7 in such a way that the helical spring 18 is biased between the press piece 20 and the press-in part 8. The press piece 20 penetrates the end face 16 of the armature 4, such that the Woodruff key 15 is held between the press piece 20 and the helical spring 10. The press piece 20 is in this case displaceable at most as far as an axial stop 24 of the axial recess 7 by the helical spring 18.

The resilient forces are in this case preferably matched in such a way that approximately half the travel is taken up via the helical spring 18. The helical spring 18 is ultimately supported on the Woodruff key 15. Since the C-value (spring rate) of the spring assembly formed of the helical spring 10 and the Woodruff key 15 is greater than the C-value of the helical spring 18, the spring assembly formed of the helical spring 10 and the Woodruff key 15 is also shifted somewhat upon actuation of the magnetic valve in accordance with the proportioning of the spring rates. There is thus a gentle transition between the linear first characteristic curve region I and the progressive characteristic curve region II of the characteristic curve K from FIG. 2. As soon as the helical spring 18 is bridged, that is to say when the end face 16 of the armature 4 bears directly against the Woodruff key 15, only the progressive spring assembly formed of the helical spring 10 and the Woodruff key 15 still acts. It is thus also possible with the magnetic valve 1 according to the second exemplary embodiment to ensure a stable, controllable magnetic valve 1.

FIG. 4 shows a further exemplary embodiment of the magnetic valve 1. Elements known from the preceding exemplary embodiments are provided with like reference signs, and reference is therefore made in this regard to the description above. In contrast to the preceding exemplary embodiment from FIG. 3, merely the helical springs 10 and 18, but not the Woodruff key 15, are provided in this case. A progressive characteristic curve of the magnetic valve 1 can be set merely by means of the provision of the two helical springs 10 and 18 arranged in parallel.

A sleeve 21 is provided as a fixing element 12 instead of the ball 13. The sleeve 21 is held with a friction fit in the axial recess 7. A pin 22 is in turn held with a friction fit in the sleeve 21, the free end of said pin cooperating with the free end of the press piece 20. The helical spring 18 is thus supported via the press piece 20, the pin 22 and the sleeve 21 on the pole core 3.

For assembly, the helical spring 18 in the armature 4 is first set to a defined resilience. The bias of the helical spring 10 in the pole core 3 is set via the sleeve 21 and/or the pole core 3, in such a way that the working air gap ALS is ensured in the assembled state. The pin 22 is pressed so far into the sleeve 21 that there is defined contact between the press piece 20 and the pin 22 to set the spring characteristic of the magnetic valve 1.

FIG. 5 shows a further exemplary embodiment of the magnetic valve 1, which differs from the preceding exemplary embodiment according to FIG. 4 in that the pin 22 is pressed directly into the pole core 3, in particular in a tapered end region 23 of the axial recess 11. By omitting the spring stop element 12, a particularly simple and cost-effective variant of the magnetic valve 1 can thus be produced.

1. A normally closed magnetic valve comprising:
a valve sleeve;
a pole core fixedly arranged in the valve sleeve and including an axial recess;
an armature including a valve tip, the armature configured to be axially displaceable in the valve sleeve; and
a helical spring acting between the pole core and the armature and configured to push the valve tip into a valve seat,
wherein the axial recess is configured (i) to receive the helical spring, at least in some regions, and (ii) to guide the helical spring.

2. The magnetic valve as claimed in claim 1, wherein the armature includes a closed end face facing the pole core.

3. The magnetic valve as claimed in claim 1, further comprising:
a Woodruff key is arranged between the armature and the helical spring.

4. The magnetic valve as claimed in claim 1, wherein:
an end face of the armature facing the pole core is at least substantially convex, and
an end face of the pole core facing the armature is at least substantially concave.

5. The magnetic valve as claimed in claim 1, further comprising:
at least one spring stop element is arranged in the axial recess with a friction fit,
wherein the at least one spring stop element is configured to set the resilience of the helical spring.

6. The magnetic valve as claimed in claim 5, wherein the at least one spring stop element is formed as one of a ball and a sleeve pressed into the axial recess.

7. The magnetic valve as claimed in claim 1, further comprising:
a further helical spring arranged in parallel with the helical spring.

8. The magnetic valve as claimed in claim 7, wherein the further helical spring is arranged in an axial recess formed in the armature.

9. The magnetic valve as claimed in claim 7, further comprising:
a press piece pushed against the pole core by the further helical spring,
wherein the press piece is axially displaceable in the axial recess.

10. The magnetic valve as claimed in claim 1, further comprising:
a pin guided through the helical spring and configured to cooperate with the press piece,
wherein the pin is arranged in the axial recess of the pole core.
